(19) United States
(12) Patent Application Publication
(10) Pub. No.: US 2007/0155371 A1
(43) Pub. Date: Jul. 5, 2007

(54) Disablement of simultaneous ringback

(76) Inventor: Brian K. Daigle, Marietta, GA (US)

Correspondence Address: SCOTT P. ZIMMERMAN, PLLC, PO BOX 3822, CARY, NC, 27519, US

(21) Appl. No.: 11/321,617

(22) Filed: Dec. 29, 2005

(51) Int. Cl. H04M 3/00

(52) U.S. Cl. 455/418

(57) ABSTRACT

Simultaneous ring control services provide control features for a priority communication, such as a communication from an emergency provider or an emergency party, within a communications network to override or otherwise disable a simultaneous ring service to multiple associated communications addresses such that only a communications address of a priority called party receives a communications signal from a priority caller. According to exemplary embodiments, a priority called party may control an alternate message or alert to a selected, non simultaneous ring communications address(es) such that the selected, non simultaneous ring communications address(es) receives information of the priority caller's communications signal.

### CROSS REFERENCE TO RELATED APPLICATIONS

Additionally, this application relates to a commonly assigned co-pending application entitled “Sender Disablement of Simultaneous Rings and Routed Rings” (Attorney Docket BS050303) filed simultaneously herewith, and of which is incorporated herein by this reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

This application generally relates to field of communications. More particularly, this invention relates to a system and method for disablement of a simultaneous ring service.

Telecommunications has experienced explosive growth, and more growth is planned as telecommunication access and numerous communications devices improve. This explosive growth is revolutionizing special services offered to subscribing customers. Of the special service offerings, the simultaneous ring service is relevant to this discussion. Today, more and more individuals (also referred to herein as “subscribers,” “users,” and “customers”) have different telephone numbers, such as, for example, different telephone numbers for his/her home, his/her office, his/her cellular phone, and his/her pager. An emergency provider is often required to dial or otherwise initiate multiple communications in order to reach the individual—that is, the emergency provider calls a first telephone number and waits to see if the individual answers the call. If the call is not answered, then the emergency provider calls a second telephone number and again waits to see if the individual answers the call. This continues with a third telephone number, a fourth telephone number, and so on until the call attempt is answered or until the emergency provider gives up trying to contact the emergency party. Consequently, this process is often frustrating for the emergency provider because the emergency provider must initiate a series of different calls to different telephone numbers before reaching the emergency provider. And, called parties may also be frustrated because despite the efforts of the emergency provider to contact the individual, the end result may still be a missed call.

Conventional simultaneous ring services provide a ringing tone on a dialed telephone number of the incoming call and on selected secondary telephone numbers. Such a service connects the emergency provider to a telephone that is answered first. As known by those of ordinary skill in the art, these simultaneous ring services may be extended to ring many different telephone numbers at the same time or alternatively, to ring a series of telephone numbers in rapid succession. Although such simultaneous ring services have provided some convenience, there are problems with implementation, with integration of emergency services (e.g., 9-1-1) to a caller using a simultaneous ring service, and with communications to evolving communications systems.

### SUMMARY

The aforementioned problems, and other problems, are reduced, according to exemplary embodiments, by methods, systems, and devices that provide control features and/or disablement of simultaneous ring services for an emergency communication.

According to some of the exemplary embodiments, a method of processing an urgent or high priority communications signal, such as an emergency provider's communications signal, to a communications address associated with a simultaneous ring service includes receiving and identifying an emergency service provider's communications signal to an emergency party's communications address that is associated with a simultaneous ring service. The emergency provider's communications signal is detected and decoded by a communications network and a server-based Simultaneous Ring Emergency Control Module of the communications network disables the simultaneous ring service of the emergency party's communications address and the emergency provider's communications signal is only communicated to the emergency party's communications address selected by the emergency provider.

In further exemplary embodiments, the Simultaneous Ring Emergency Control Module of the communications network may initiate communications of an alternate message or alert to a disabled simultaneous ring communications addresses such that the disabled communications address(es) receives a shared notification of the emergency provider's communications signal. In still further exemplary embodiments, a communications device of the emergency service provider may include the Simultaneous Ring Emergency Control Module to control the alternate message or alert to the disabled simultaneous ring communications addresses.

According to some of the exemplary embodiments, an individual (also referred to herein as the “calling party”, “emergency caller”, and/or “user”) uses a communications device (e.g., POTS telephone, cellular phone, VoIP phone, and others) associated with a simultaneous ring service to request an emergency service, such as dialing 9-1-1 to connect with a PSAP. A communications network uses network information associated with an emergency party's communications address of the emergency party's communications device to select and to route the emergency communication to an appropriate PSAP (or other emergency service provider). If the communications connection between the PSAP and the individual is disconnected or otherwise terminated and the PSAP attempts to subsequently contact the individual, then an emergency provider's communications signal overrides the simultaneous ring service such that only an emergency party's communications address entered by the PSAP receives the emergency provider's communications signal. That is, when the emergency service provider initiates the communication to the emergency party's communications address associated with the simultaneous ring service, the communications network bypasses the simultaneous ring service(s) associated with the emergency party's communications address (as previously instructed by an emergency party's communications signal to the PSAP). In further exemplary embodiments, the emergency party's communications device may enable the emergency party to control an alternate message or alert to the disabled simultaneous ring communications addresses such that these communications address(es) receives a shared, emergency notification of the outgoing emergency party's communications signal, information of the communications connection among the emergency provider's communications device and the selected communications device of the emergency party, and/or the emergency provider's communications signal.

According to other exemplary embodiments, a computer program product includes a computer-readable medium and a simultaneous ring emergency control module stored on the computer readable medium. The simultaneous ring emergency control module detects an emergency provider's communications signal from an emergency service provider's communications address to an emergency party's communications address (e.g., a communications address of an emergency party of a previous connection, a communications address of an activated alarm, and others), deactivates and/or otherwise disables a simultaneous ring service of the emergency party's communications address, and initiates communication of the emergency provider's communications signal to the communications address such that simultaneous ring services for other communications addresses (e.g., cellular phone, work phone, home computer, and others associated with the communications address) are disabled and only the communications address receives the emergency provider's communications signal. According to various embodiments, the computer-readable medium may be stored in an emergency provider's communications device, a communications network, and/or a remote data server.

Other systems, methods, and/or computer program products according to the exemplary embodiments will be or become apparent to one with skill in the art upon review of the following drawings and detailed description. It is intended that all such additional systems, methods, and/or computer program products be included within and protected by this description and be within the scope of this invention.

### DESCRIPTION OF THE DRAWINGS

These and other features, aspects, and advantages of the exemplary embodiments are better understood when the following description is read with reference to the accompanying drawings, wherein:

FIG. 1 is a schematic of a simultaneous ring communications system as known in the prior art;

FIG. 2 is an exemplary schematic of the simultaneous ring communications system of FIG. 1;

FIG. 3 is a schematic of a simultaneous ring control communications system according to some of the embodiments;

FIG. 4 is an exemplary schematic of the simultaneous ring control communications system of FIG. 3;

FIG. 5 is schematic of another simultaneous ring control communications system according to some of the embodiments;

FIG. 6 is a block diagram of a communications device having a simultaneous ring control module according to some of the exemplary embodiments;

FIG. 7 is a schematic of still another simultaneous ring control communications system according to some of the exemplary embodiments;

FIG. 8 is an exemplary schematic of the simultaneous ring control communications system of FIG. 7;

FIG. 9 is a perspective view of a caller identification display of a selected, non simultaneous ring communications device according to some of the exemplary embodiments;

FIG. 10 is a perspective view of another caller identification display of a selected, non simultaneous ring communications device according to some of the exemplary embodiments;

FIG. 11 is a perspective view of still another caller identification display of a selected, non simultaneous ring communications device according to some of the exemplary embodiments; and

FIG. 12 is a schematic of yet another simultaneous ring control communications system according to some of the exemplary embodiments.

### DESCRIPTION

The exemplary embodiments now will be described more fully hereinafter with reference to the accompanying drawings. The reader should recognize, however, that the exemplary embodiments may be embodied in many different forms and should not be construed as limited to the embodiments set forth herein. These embodiments are provided so that this disclosure will be thorough and complete and will fully convey the scope of the exemplary embodiments. Moreover, all statements herein reciting exemplary embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods of the exemplary embodiments. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing the exemplary embodiments. Those of ordinary skill in the art further understand that the exemplary hardware, software, processes, methods, and/or operating systems described herein are for illustrative purposes and, thus, are not intended to be limited to any particular named manufacturer.

The exemplary embodiments describe methods, systems, and devices that provide control features and/or disablement of simultaneous ring services for an urgent and/or high priority communication, such as, for example, an emergency communication to a party's communications address, herein referred to as an “emergency party's communications address” In the description that follows, the term “emergency” is used to refer to urgent and/or high priority communications for ease of explanation. However, it should be appreciated that the invention is not limited to emergency communications but may also be applicable to other types of urgent and/or high priority communications.

In some of the exemplary embodiments, a method of processing an emergency provider's communications signal to an emergency party's communications address associated with a simultaneous ring service includes receiving the emergency provider's communications signal and identifying an emergency service provider's communications address, associating an emergency party's communications profile, disabling or otherwise deactivating a simultaneous ring service of the emergency party's communications address, and communicating the emergency provider's communications signal to the emergency party's communications address such that simultaneous ringing or round-robin ringing to a plurality of different communications addresses of the simultaneous ring service is disabled, and only the emergency party's communications address receives the emergency provider's communications signal. In further embodiments, some of the disabled plurality of different communications addresses may receive a shared, emergency communications signal that includes an alert of the emergency provider's communication to the emergency party's communications address.

In some of the exemplary embodiments, an individual (also referred to herein as the “party”, the “calling party”, the “emergency caller”, and/or the “user”) uses a communications device (e.g., POTS telephone, cellular phone, VoIP phone, and others) associated with a simultaneous ring service to request an emergency service, such as dialing 9-1-1 to connect with a Public Safety Answering Point (PSAP) (also referred to herein as “emergency services provider”). A communications network uses network information associated with an emergency party's communications address of the emergency party's communications device (e.g., Automatic Number Identification (ANI), Automatic Location Identification (ALI), enhanced 9-1-1 services, and so on) to select/correlate a Public Safety Answering Point (PSAP) and to route the emergency communication to the PSAP (or other emergency service providers). If the communications connection between the PSAP and the individual is disconnected or otherwise terminated and the PSAP attempts to subsequently contact the individual, then an emergency provider's communications signal overrides the simultaneous ring service such that only an emergency party's communications address entered by the PSAP receives the emergency provider's communications signal. That is, when the emergency service provider initiates the communication to the emergency party's communications address associated with the simultaneous ring service, the communications network bypasses the simultaneous ring service(s) associated with the emergency party's communications address (as previously instructed by the emergency party's communications signal). Consequently, the emergency party's communications device rings to provide an alert of the incoming emergency provider's communications signal. In further exemplary embodiments, the emergency party's communications device may enable the emergency party to control an alternate message or alert to the disabled simultaneous ring communications addresses such that these communications address(es) receives a shared, emergency notification of the outgoing emergency party's communications signal, information of the communications connection among the emergency provider's communications device and the selected communications device of the emergency party, and/or the emergency provider's communications signal.

The emergency service provider's communications address may be a publicly registered and/or otherwise publicly recognized emergency service provider, such as the PSAP, a police department, a fire department, emergency medical personnel, poison control, and other registered providers of emergency services. The emergency service provider's communications address may also be a user-defined communications address such as a telephone number or an Internet Protocol (IP) based communications address to a doctor's office or to a pharmacy. The communications signals (e.g., the emergency provider's communications signal, the emergency party's communications signal, and/or the shared, emergency communications signal) may be associated with multiple communications devices of each respective communications address, such as an emergency party's POTS phone and computer coupled with a modem communicating with a telecommunications network from the same switch (e.g., Service Node).

As used herein, the term “communications device” includes wired and wireless communications devices, such as a mobile phone, a wireless phone, a WAP phone, a satellite phone, a computer, a modem, a pager, a digital music device, a digital recording device, a personal digital assistant, an interactive television, a digital signal processor, and a Global Positioning System device. The communications device may include any computer, peripheral device, camera, modem, storage device, telephone, personal digital assistant, and/or mobile phone. The communications network may include coaxial cables, copper wires, fiber optic lines, and/or hybrid-coaxial lines. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may even include wireless portions utilizing any portion of the electromagnetic spectrum and any signaling standard (such as the I.E.E.E. 802 family of standards).

Further, as used herein, the term “communications signal” (e.g., emergency party's communications signal, emergency provider's communications signal, and/or shared, emergency communications signal) includes switched communications signals and/or digital communications signals that may include facsimile, electronic mail (e-mail), text, video, audio, and/or voice in a variety of formats, such as dual tone multi-frequency, digital, analog, and/or others. Additionally, the term “emergency party's communications profile” may include: (1) executable programs, such as a software application, (2) an address, location, and/or other identifier of executable instructions, such as a disabled, simultaneous ring address to communicate the shared, emergency communications signal, and/or (3) simultaneous ring emergency control instructions, including configuration, authenticity, security, and others. Still further, the term “processing,” as used herein, encompasses every event from the time the communications device (of the emergency provider or the emergency party) goes off-hook to the termination of the communications signal (e.g., hanging up a telephone). “Processing” of the communications signals includes routing a voice path and signaling setup and intelligence (e.g., Local Number Portability queries, queries to retrieve Calling Name/Number information, intelligence queries by the AIN components, and standard signaling messages to determine communications routing paths). The term “processing” also includes monitoring an established communications link for possible entry of a simultaneous ring emergency control instruction of a communications signal, such as a switch hook flash and/or other events that indicate a party (e.g., emergency party or emergency provider) has requested a shared, emergency communications signal to a disabled simultaneous ring communications address. Finally, in various embodiments, the communications signals, simultaneous ring emergency control instructions, and/or emergency party communications profile may be stored by the communications network, a peripheral storage device connected to the communications network, the emergency provider's communications device, the emergency party's communications device, and/or other connected networks.

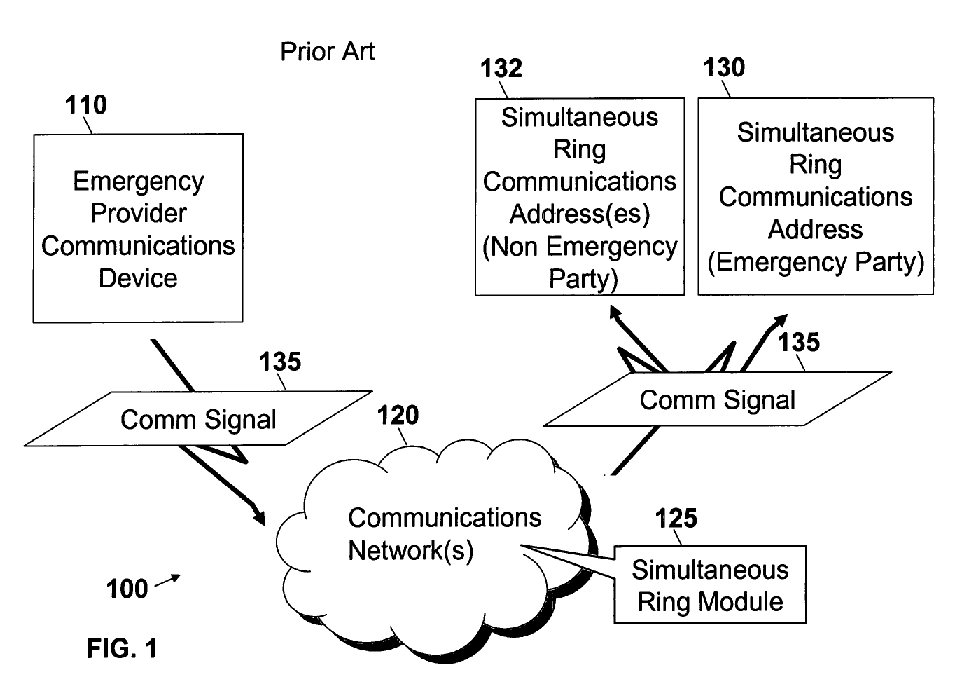

Referring now to the figures, FIG. 1 illustrates a schematic of an emergency provider's communications signal communicated within a conventional simultaneous ring communications system 100 (labeled “Prior Art”). The communications system 100 includes an emergency provider's communications device 110 communicating an emergency provider's communications signal 135 to a simultaneous ring service line, at least one communications network 120 having a server-component of a Simultaneous Ring Module 125 to control simultaneous or round-robin routing of communications signal to multiple communications addresses of the simultaneous ring service line, and a plurality of simultaneous ring communications addresses including a communications address of an emergency party (shown as “Simultaneous Ring Communications Address (Emergency Party)”) 130 and one or more communications addresses not available to the emergency party (shown as “Simultaneous Ring Communications Address(es) (Non Emergency Party)”) 132. In general, an emergency provider uses his/her communications device 110 to enter or otherwise input an emergency party's communications address to initiate the emergency provider's communications signal 135 to a plurality of simultaneous ring communications addresses 130, 132. The communications network(s) detects and decodes the emergency provider's communications signal 135, associates a plurality of communications addresses subscribing to a simultaneous ring service 130, 132, and simultaneously (or, alternatively, round-robin) communicates the communications signal 135 to the plurality of communications addresses 130, 132.

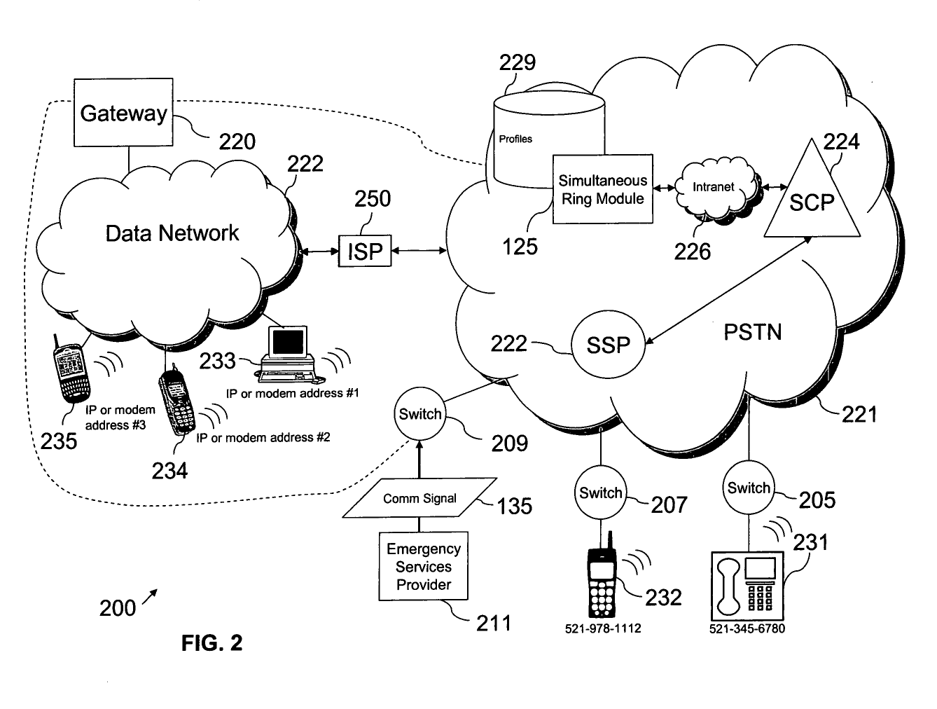

FIG. 2 illustrates a more detailed schematic of the simultaneous ring communications system 200 of FIG. 1. The simultaneous ring communications system 200 depicts communications paths among at least two communications network(s) 221, 222, the emergency provider's communications device 211, and a plurality of communications devices at various communications addresses—shown as POTS phone 231 having a communications address of 571-345-6780, cellular phone 232 having a communications address of 571-978-1112, computer system 233 having a first IP or modem communications address, a VoIP phone 234 having a second IP or modem communications address, and a PDA 235 having a third IP or modem communications address. The POTS phone 231 is coupled with a communications switch 205 connected to a telecommunications network 221. The cellular phone 232 transmits and receives signals with a Mobile Switching Office (MSO) (not shown) that communicates with switch 207 to connect to the telecommunications network 221. The telecommunications network 221 includes a service switching point (SSP) 222, a service control point (SCP) 224, an Intranet 226 (for the telecommunications provider to administer and program the telecommunications network 221 components), a Simultaneous Ring Dataserver having the Simultaneous Ring Module 125, and a database of one or more Simultaneous Ring profiles 229. The system 200 further includes an Internet Service Provider (e.g., America On-Line) 250, a data network 222 communicating with communications devices 233, 234, and 235, a gateway 270, and a third communications switch 209 connected to the emergency provider's communications device 211 (that is capable of communications with the telecommunications network 221 and with the data network 222). Each switch 205, 207, and 209 allows the connected communications device to transceive electronic communication signals via the data network 222 (e.g., world wide electronic data network such as an Internet, an Intranet, and/or an Extranet) and/or the telecommunications network 221 (e.g., a central office (CO), MSO, and/or a combination CO/MSO). The telecommunications network 221 may use any means of coupling one of the switches 205, 207, and 209 to the telecommunications network 221, but the coupling means is preferably high-capacity, high-bandwidth optical transport services, Gigabit Ethernet services, and/or the like. As those of ordinary skill in the art of telecommunications understand, the telecommunications network 221 could also link each of the switches 205, 207, and 209 via other appropriate means, such as, for example a Synchronous Optical Network (SONET) structure with redundant, multiple rings.

The emergency service provider uses his/her communications device 211 to enter or otherwise input a simultaneous ring communications address to initiate the emergency provider's communications signal 135 to a plurality of communications addresses associated with the simultaneous ring service. The simultaneous ring service initiates communication of the emergency provider's communications signal 135 to each of the associated communications addresses 231, 232, 233, 234, and 235. For example, the communications signal from the emergency provider's communications device 211 is routed to the telecommunications network 221 via switch 209. Alternatively, the communications signal from the emergency provider's communications device 211 may be routed through switch 209 to the gateway 270 for further communication and/or processing with the data network 222 and/or the telecommunications network 221. The communications signal 135 is detected at SSP 222 and decoded by the SCP 224 and by the Simultaneous Ring Module 125 of the communications network 221 to associate the simultaneous ring communications addresses 231, 232, 233, 234, and/or 235. That is, a simultaneous ring service to a plurality of communications addresses is detected by the SSP 222, then the SCP 224 and the Simultaneous Ring DataServer having the Simultaneous Ring Module further processes and routes the communications signal 135 simultaneous or in a round-robin fashion to each of the plurality of communications addresses 231, 232, 233, 234, and/or 235 such that each address presents an alert until a communications device at one of the plurality of communications addresses answers the incoming emergency provider's communications signal to establish a communications connection. Any of the plurality of simultaneous ring communications addresses 231, 232, 233, 234, and/or 235 may answer the incoming emergency provider's communications signal, and, consequently, the emergency services provider may not reach the emergency party (e.g., a party intended to communicate with the emergency services provider).

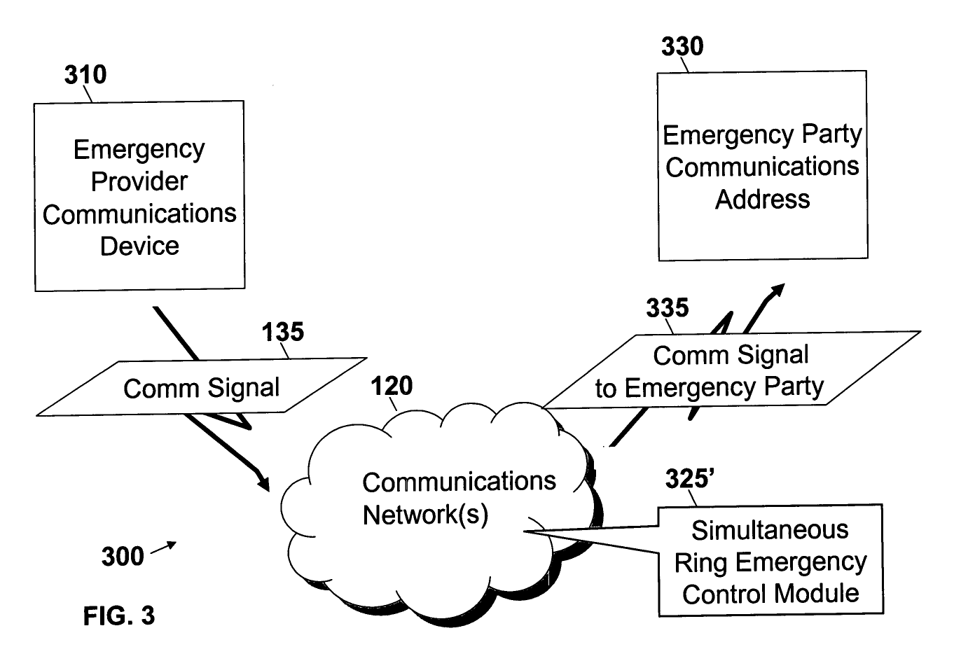

Referring now to FIG. 3, a simultaneous ring emergency control communications system 300 illustrates a schematic of a simultaneous ring emergency control communications system 300. The communications system 300 includes an emergency provider's communications device 110 that communicates a communications signal 135 to at least one communications network 120 having a server-component of a Simultaneous Ring Emergency Control Module 325′ that overrides, disables, or otherwise bypasses simultaneous or round-robin routing of the communications signal 135 to the simultaneous service line such that an emergency party's communications signal 335 is only communicated to an emergency party's communications address 330.

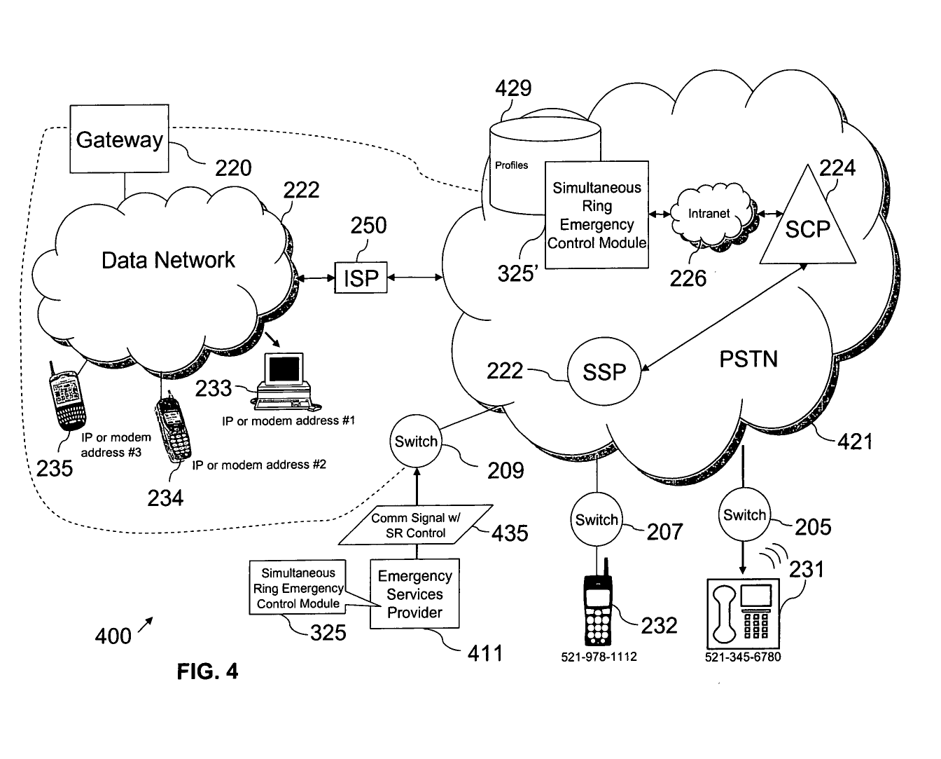

FIG. 4 illustrates a more detailed schematic of a simultaneous ring emergency control communications system 400 similar to the communications system 300 of FIG. 3; however, an emergency provider's communications device 411 includes a communications device having a Simultaneous Ring Emergency Control Communications Module 325. The simultaneous ring emergency control communications system 400 depicts the communications paths among at least two communications network(s) 421, 222, the emergency provider's communications device 411 having the Simultaneous Ring Emergency Control Module 325, and a plurality of simultaneous communications devices at various communications addresses—shown as POTS phone 231 having a communications address of 571-345-6780, cellular phone 232 having a communications address of 571-978-1112, computer system 233 having a first IP or modem communications address, VoIP phone 234 having a second IP or modem communications address, and PDA 235 having a third IP or modem communications address. Similar to communications system 200 of FIG. 2, the POTS phone 231 is coupled with the communications switch 205 connected to the telecommunications network 421. The cellular phone 232 transmits and receives signals with the Mobile Switching Office (MSO) (not shown) that communicates with switch 207 to connect to the telecommunications network 421. The telecommunications network 421 includes the service switching point (SSP) 222, the service control point (SCP) 224, the Intranet 226, a Simultaneous Ring Dataserver having a Simultaneous Ring Emergency Control Module 325′, and a database of one or more Simultaneous Ring Emergency Control profiles 429. The system 400 further includes the Internet Service Provider 250, the data network 222 communicating with communications devices 233, 234, and 235, the gateway 270, and the third communications switch 209 connected to the emergency provider's communications device 411.

The emergency provider uses his/her communications device 411 to enter or otherwise input an emergency party communications address to an intended emergency party or other simultaneous ring instruction(s) to initiate an emergency party's communications signal 335 only to the emergency party's communications address 231 such that all other associated simultaneous ring communications addresses 232, 233, 234, and 235 are not simultaneously rung or round-robin rung. The communications network 222 or 421 detects and decodes the emergency provider's communications signal 335 for the emergency party's communications address, and only communicates the communications signal 335 to the selected emergency party's communications addresses 231. That is, the communications network 222 or 421 does not communicate the emergency provider's communications signal 335 to other associated simultaneous ring communications addresses 232, 233, 234, and 235. The emergency provider's communications signal 335 for the emergency party's communications address is detected at SSP 222 and decoded by the SCP 224 and/or by the Simultaneous Ring Emergency Control Module 325′ of the telecommunications network 421 to access a Simultaneous Ring Emergency Control Profile that (1) associates each communications address 231, 232, 233, 234, and/or 235 of the simultaneous ring service line, (2) includes instructions to disable, bypass, or otherwise deactivate simultaneous ring service to selected, communications addresses 232, 233, 234, and 235 not identified in the emergency provider's communications signal 335, (3) includes instructions to only communicate the emergency provider's communications signal 335 to a communications address of an emergency party 231 having the simultaneous ring service, (4) includes instructions to otherwise enable emergency control of the simultaneous ring service for a user-defined communications address such as a telephone number of a doctor's office (e.g., password on pin code requirement and others), (5) includes instructions to generate an emergency notification communications signal to the communications address having disabled simultaneous ring service, and/or (6) includes instructions to otherwise manage simultaneous ring emergency controlled features. Consequently, in the communications system 400, the emergency party's communications signal 335 is processed by the Simultaneous Ring Emergency Control Module 325′ of the communications network 421 for routing to only the emergency party's communication address 231.

The communications address of the emergency party 231 may be selected by the emergency provider (e.g., inputting the actual communications address of the emergency party), or, alternatively, the communications address of the emergency party may be recognized by the server-component Simultaneous Ring Emergency Control Module 325′ as a simultaneous ring communications address having recently dialed an emergency provider's communications address (e.g., a record of an emergency party's communications signal from the communications address 231 to a recognized emergency provider's communications address (e.g., 9-1-1 or other publicly recognized emergency service provider or a user-defined emergency service provider).

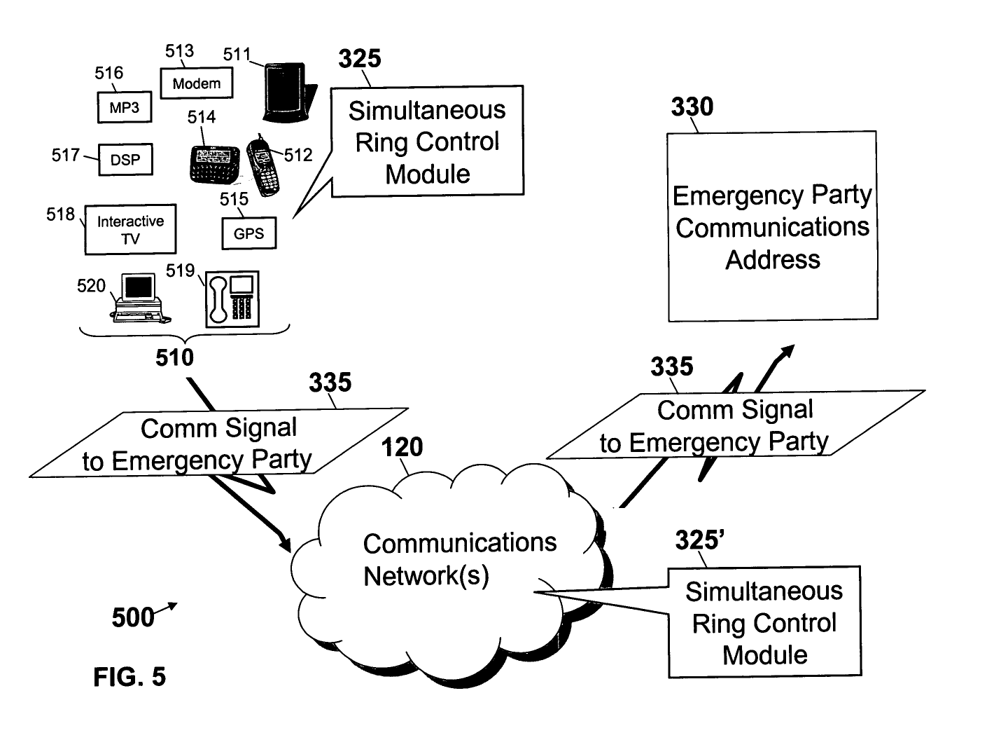

FIG. 5 illustrates a simultaneous ring emergency control communications system 500 having various types of emergency provider's communications devices 510. Similar to the communications system 400 of FIG. 4, the emergency provider's communications device 510 includes the Simultaneous Ring Emergency Control Module 335 that may be used by the emergency provider to initiate the emergency provider's communications signal 335 for selective routing to the emergency party's communications address associated with the simultaneous ring service. The Simultaneous Ring Emergency Control Module 325 operates within any of these various types of communications devices 510 that include a personal digital assistant (PDA) 511, a Voice over Internet Protocol (VOIP) phone 512, a modem 513, an interactive pager 514, a Global Positioning System (GPS) device 515, a digital musical recorder device 516, any computer system utilizing a digital signal processor 517, an interactive television 518, a Plain Old Telephone System (POTS) phone 519, and/or a computer 520. The communications device 510 may also include watches, radios, vehicle electronics, clocks, printers, gateways, and other apparatuses and systems. As those of ordinary skill in the art understand, the communications device 510 and the Simultaneous Ring Emergency Control Module 325 has the intelligence for appropriate communicating with the selected communications device of the emergency party 330. For example, if the communications device 510 uses the Wireless Application Protocol (WAP) technique, then the emergency provider's communications signal 335 for the emergency party's communications address is formatted using the Wireless Mark-up Language (WML) and configured according to standards known in the art. The Wireless Mark-up Language (WML) and the WAP technique are known and will not be further described. This is a description of a solution for a specific wireless protocol, such as WAP. This solution may be clearly extended to other wireless protocol, such as i-mode, VoiceXML (Voice extensible Markup Language), Dual Tone Multi-Frequency (DTMF), and other signaling means.

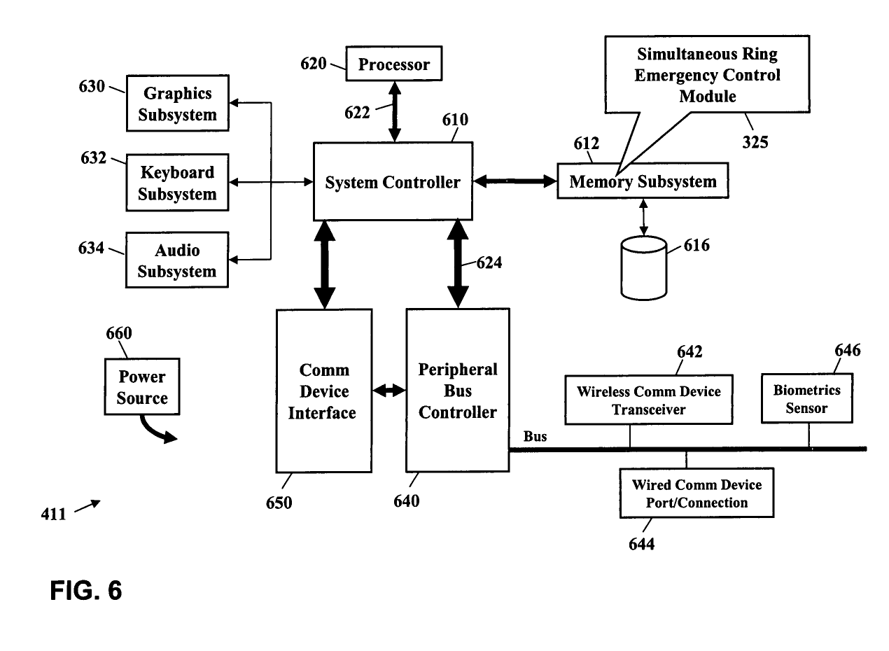

FIG. 6 is a block diagram of exemplary details of an emergency party's communications device 411 shown in FIG. 4. The communications device 411 includes the Simultaneous Ring Emergency Control Module 325 that operates within a system memory device 612. The Simultaneous Ring Emergency Control Module 325, however, could also reside in flash memory or a peripheral storage device 616. The communications device 411 also has one or more central processors 620 executing an operating system. The operating system, as is well known, has a set of instructions that control the internal functions of the communications device 411. A system bus 622 communicates signals, such as data signals, control signals, and address signals, between the central processor(s) 620 and a system controller 610. The system controller 610 provides a bridging function between the memory subsystem 612, the one or more central processors 620, a graphics subsystem 630, a keyboard subsystem 632, an audio subsystem 634, a PCI (Peripheral Controller Interface) bus 624, and a Communications (“Comm”) Device Interface 650. The PCI bus 624 is controlled by a Peripheral Bus Controller 640. The Peripheral Bus Controller 640 is an integrated circuit that serves as an input/output hub for various peripheral ports and/or transceivers. These peripheral ports allow the communications device 411 to communicate with a variety of communications devices through networking ports (such as SCSI or Ethernet) that include Wireless Communications (“Comm”) Device Transceiver 642 (such as Wireless 802.11 and Infrared) and Wired Communications (“Comm”) Device Port/Connection 644 (such as modem V90+ and compact flash slots). These peripheral ports could also include other networking ports, such as, a serial port (not shown) and/or a parallel port (not shown). The Comm Device Interface 650 allows the communications device 411 to monitor, detect, receive, and decode incoming communications signals to the communications device(s) connected to the Wireless Comm Device Transceiver 642 and/or the Wired Comm Device Port/Connection 646. Further, the Comm Device Interface 650 transmits the outgoing communications signal and/or simultaneous ring instructions 335 to the Wireless Comm Device Transceiver 642 and/or the Wired Comm Device Port/Connection 646. Still further, the communications device 411 may include a power source 660, such as a rechargeable battery to provide power and allow the communications device 411 to be portable. In alternate embodiments, the communications device 411 could include its own telephone line (or other communications connection) to the communications network 120 (not shown). Another alternative may include the communications device 411 incorporated into a specially designed communications device (not shown). Those of ordinary skill in the art understand that the program, processes, methods, and systems described herein are not limited to any particular architecture or hardware.

The processors 620 may be implemented with a digital signal processor (DSP) and/or a microprocessor. Advanced Micro Devices, Inc., for example, manufactures a full line of microprocessors (Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Texas Instruments offers a wide variety of digital signal processors (Texas Instruments, Incorporated, P.O. Box 660199, Dallas, Tex. 75266-0199, Phone: 972-995-2011, www.ti.com) as well as Motorola (Motorola, Incorporated, 1303 E. Algonquin Road, Schaumburg, Ill. 60196, Phone 847-576-5000, www.motorola.com). There are, in fact, many manufacturers and designers of digital signal processors, microprocessors, controllers, and other components that are described in this patent. Those of ordinary skill in the art understand that this components may be implemented using any suitable design, architecture, and manufacture. Those of ordinary skill in the art, then understand that the exemplary embodiments are not limited to any particular manufacturer's component, or architecture, or manufacture.

The system memory device (shown as memory subsystem 612 or peripheral storage device 616) may also contain one or more application programs. For example, an application program may cooperate with the operating system and with a video display unit (via graphics subsystem 630) to provide a GUI for the Simultaneous Ring Emergency Control Module 325. The GUI typically includes a combination of signals communicating with the graphics subsystem 630 and/or the keyboard subsystem 632. The GUI provides a convenient visual and/or audible interface with the user of the communications device 411. As is apparent to those of ordinary skill in the art, the user (e.g., calling party) interacts with the Simultaneous Ring Emergency Control Module over a variety of mediums, such as, for example, a stylus, keyboard, and punch buttons of the keyboard subsystem 632, a display screen of the graphics subsystem 630, and/or a voice-activated menu prompt of the audio subsystem 634. Additionally, the peripheral bus controller 640 provides an interface with a biometrics sensor 646, such as, for example, a fingerprint ID device. The biometrics sensor 646 may distinguish between different users that share or otherwise use the communications device 411. Further, the biometrics sensor 646 may provide security features that prevent unauthorized users from exploiting the communications device 411. The biometrics sensor 646 could also comprise retina recognition device and software, DNA/RNA recognition device and software, facial recognition device and software, speech recognition device and software, and/or scent recognition device and software.

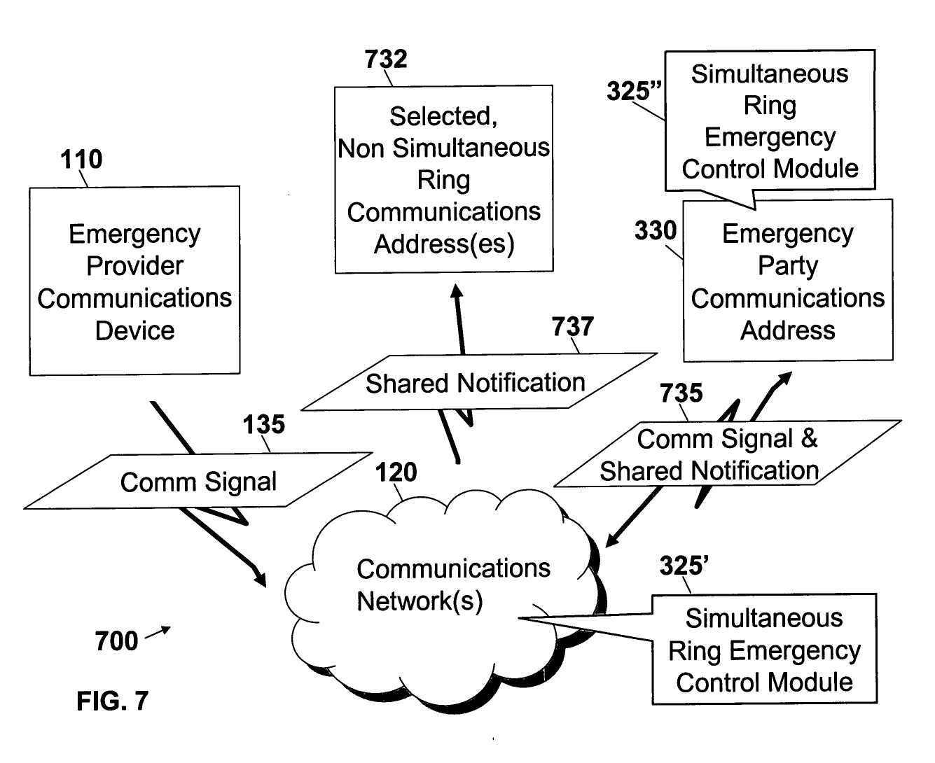

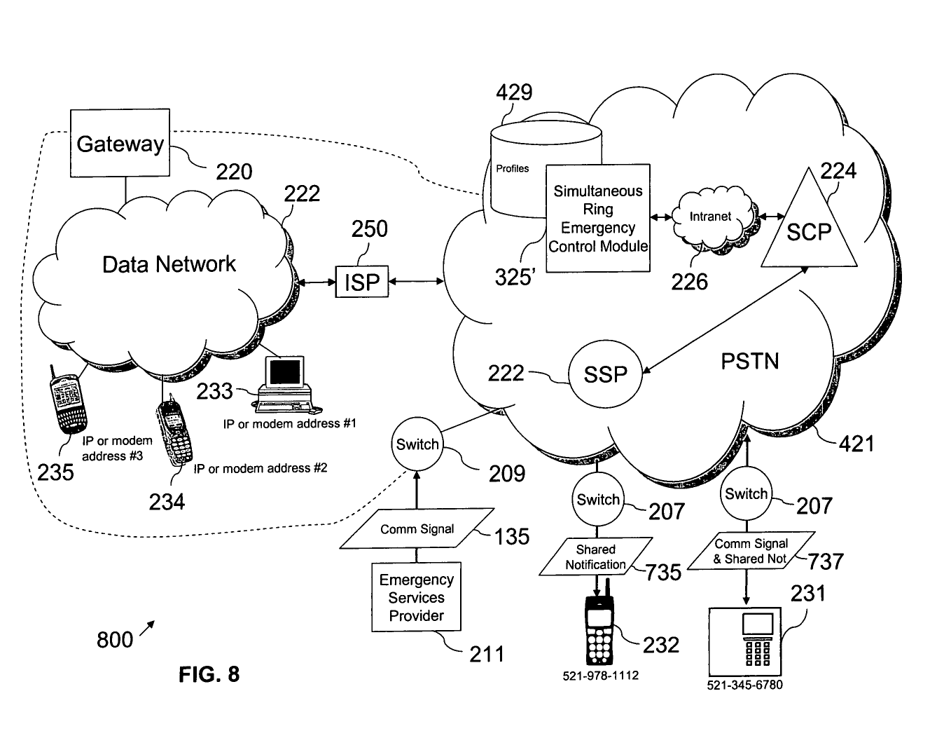

FIG. 7 illustrates a simultaneous ring emergency control communications system 700 similar to communications system 300 of FIG. 3; however the emergency party's communications device 330 includes a Simultaneous Ring Emergency Control Module 325″ that generates and initiates communication of an emergency, shared notification communications signal with the emergency provider's communications signal 735 via the communications network 120 to selected, non simultaneous ring communications addresses 730. The server-component Simultaneous Ring Emergency Control Module 325′ detects and decodes the response signal 735 from the emergency party's communications device 330, associates data of the Simultaneous Ring Emergency Control profile for the emergency party's communications address 330, and initiates communication of the emergency, shared notification communications signal 737 to the selected, non simultaneous ring communications devices 732. For example, as shown in FIG. 8, the emergency provider initiates a communications signal 135 to a simultaneous ring service line that is associated with communications addresses 231, 232, 233, 234, and 235. The Simultaneous Ring Emergency Control Module 325′ of the communications network detects the incoming communications signal 135, identifies the associated communications addresses of the emergency party 231, and accesses a Simultaneous Ring Emergency Control profile that includes instructions to only route the emergency provider's communications signal to POTS phone 231. Upon routing the communications signal to POTS phone 231 (or, alternatively upon detecting an off-hook state of the POTS phone 231 to answer the emergency provider's communications signal), the Simultaneous Ring Emergency Control profile includes instructions for the Simultaneous Ring Emergency Control Module 325′ to generate the emergency, shared notification to a selected, non simultaneous ring communications address shown as cellular phone 232. Alternatively, upon answering the incoming emergency provider's communications signal, the Simultaneous Ring Emergency Control Module 325″ of the emergency party's communications device may generate and initiate communication of the emergency, shared notification communications signal with the emergency provider's communications signal 735 to the selected, non simultaneous ring communications address 232 via the telecommunications network 421. Regardless of whether the telecommunications network or the emergency party's communications device generates the emergency, shared notification communications signal, the emergency shared notifications communications signal 737 communicated to the selected communications address 232 presents a message or alert that notifies the selected, non simultaneous ring communications address 232 of the emergency provider's communications signal to the emergency party's communications address 231.

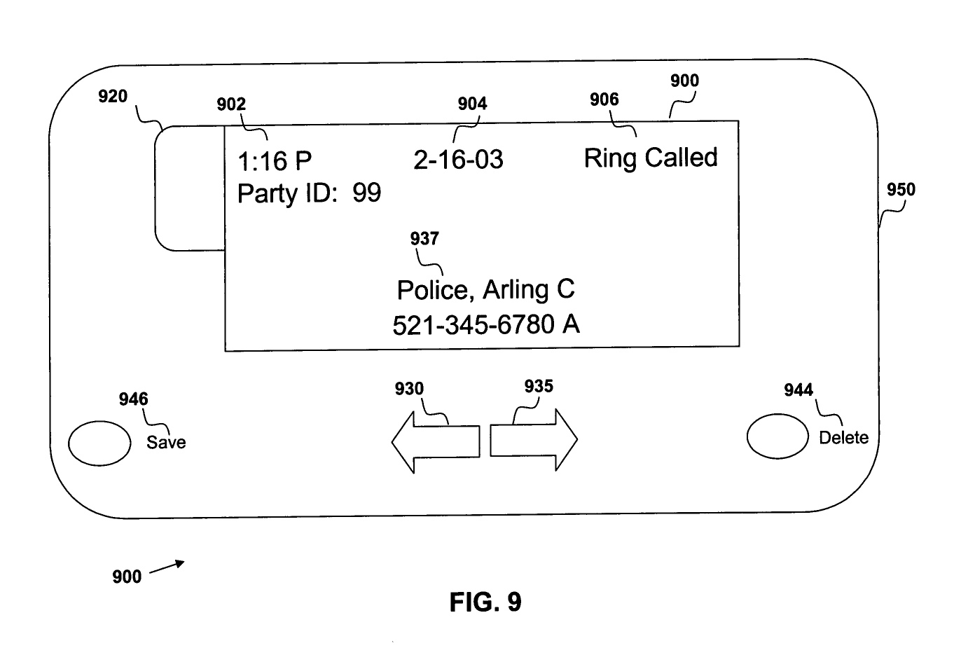

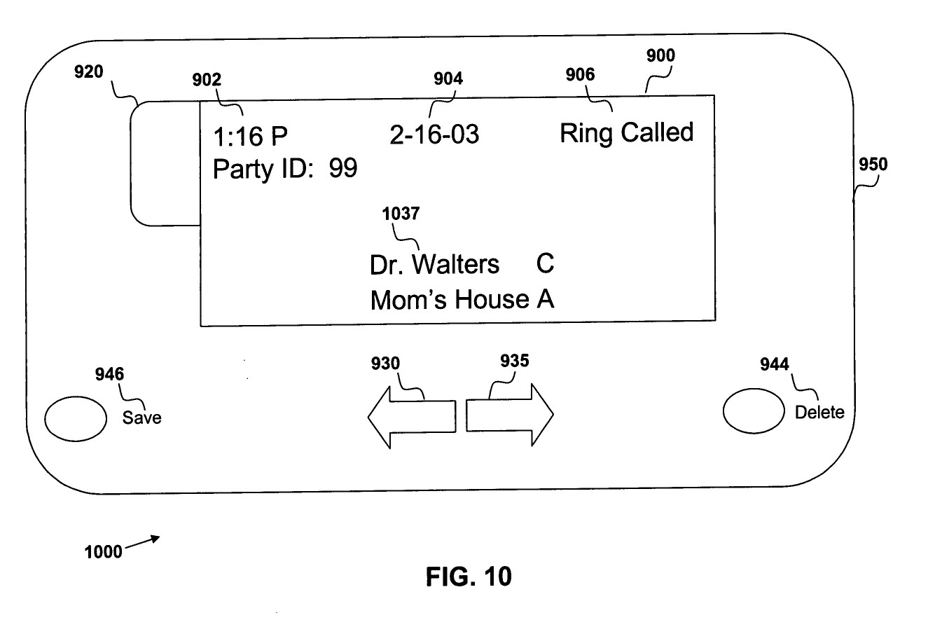

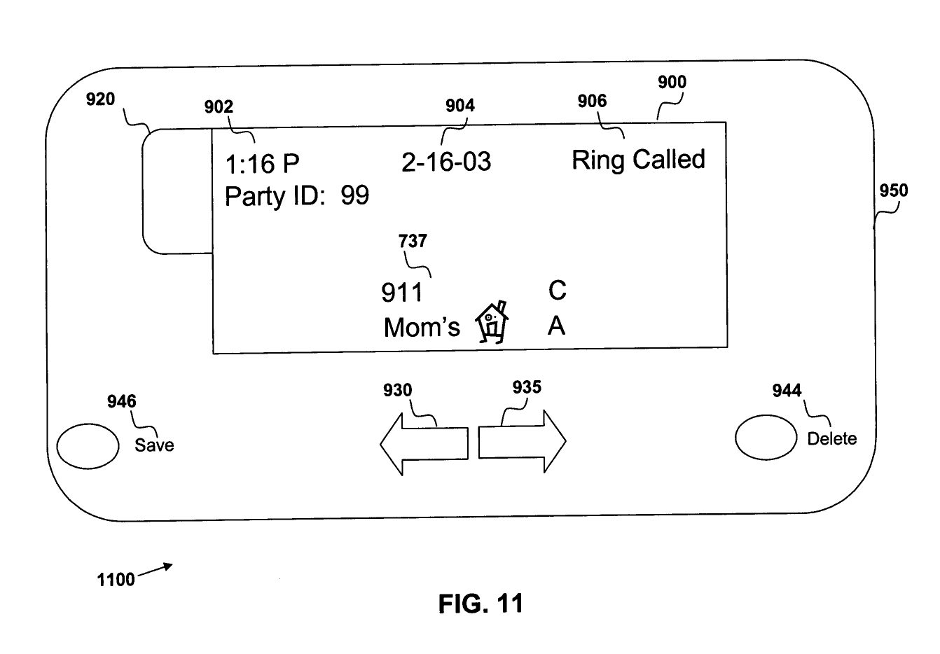

FIG. 9 illustrates an exemplary schematic of a conventional CallerID device 900 that may be coupled with a selected, non simultaneous ring communications device such as reference numeral 732 shown in FIG. 7. The CallerID device 900 includes a display screen 900 having a time identifier 902, a date identifier 904, a numeric identifier 906 of an incoming CallerID signal, a lighted panel 920 that alerts the emergency provider of a new, incoming, and/or stored ICLID signal, a “Save” punch button 946, a “Delete” punch button, a left arrow button 930, a right arrow button 935, and a housing 950 that protects the internal componentry of the CallerID device 900. Typically, the CallerID device 900 receives an incoming ICLID signal and displays an originating NANP number (i.e., the telephone number of an emergency provider for an incoming call) and/or a name associated with the originating NANP number to display 945. Conventional CallerID devices comply with standards known in the art that limit the display of the ICLID signal to two lines of text, each line containing approximately fifteen (15) characters. As shown in FIG. 9, when the CallerID device 900 receives the emergency, shared notification communications signal 937, a display presents the emergency provider's identity shown as “Police, Arlin C” with the “C” indicating that the emergency provider (i.e., “Police, Arlin”) is the calling party and also presents the emergency party's communications address shown as “521-345-6780 A” with the “A” indicating a selected communications address that is answered by the emergency party. FIGS. 10 and 11 illustrate alternate display's of the emergency, shared notification signal 1037 and 1137 in devices 1000 and 1100, respectively. For example, the display of FIG. 10 presents emergency, shared notification signal 1037 with the emergency provider's identity shown as “Dr. Walters C” with the “C” identifying that the emergency provider (i.e., “Dr. Walters”—an emergency provider selected by the user and not publicly recognized) is the calling party and also presents the emergency party's communications address shown as “Mom's House A” with the “A” indicating a selected communications address that is answered by the emergency party (i.e., “Mom's House”—an emergency party's communications address that is customized for the selected, non simultaneous ring communications device). Another example is the display of FIG. 11 that presents emergency, shared notification communications signal 1137 with the emergency provider's identity shown as “911 C” with the “C” identifying that the calling party is a “9-1-1” provider and also presents the emergency party's communications address shown as “Mom's”, a doodle or picture of a house, and an “A” indicating a selected communications address that is answered by the emergency party. Other emergency, shared notification communications signals may be used, including, text, audio, video, and doodles. Further, the CallerID device 900 of FIGS. 9, 10 and 11 may store the presentation of the emergency, shared notification communications signal 937, 1037, and 1137.

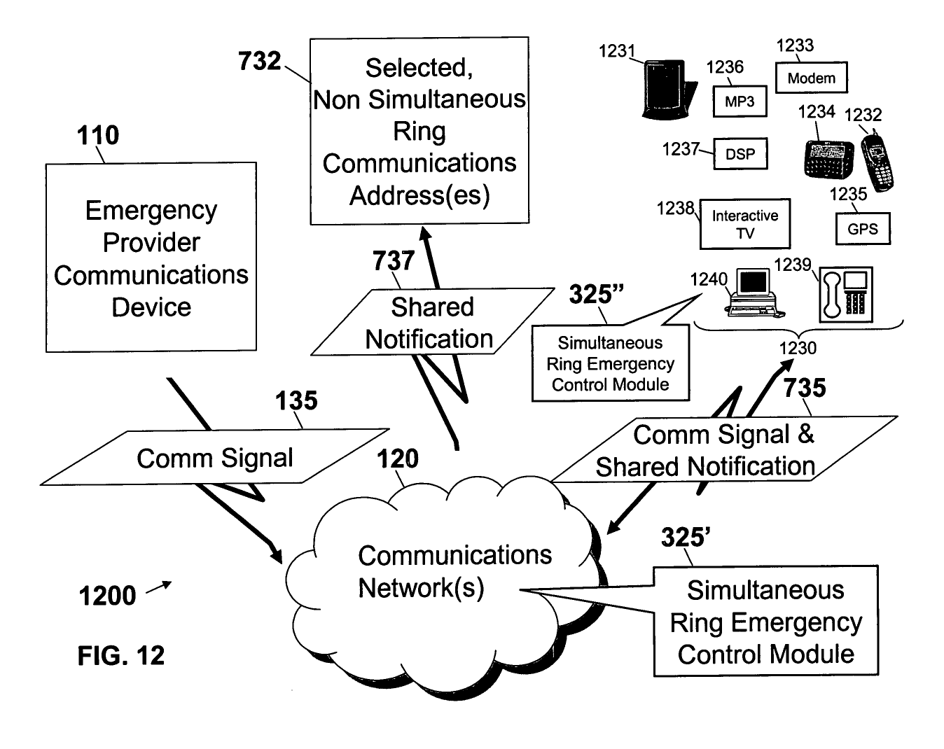

FIG. 12 is a schematic of a simultaneous ring emergency control communications system 1200 similar to communications system 700 of FIG. 7; however communications system 1200 further includes various types of communications devices 1230 that may be used by the emergency party to communicate the emergency, shared notification communications signal to selected, non simultaneous ring communications address(es) 732 via the communications network 120. Further, the Simultaneous Ring Emergency Control Module 325″ (and/or the server-component Simultaneous Ring Emergency Control Module 325′) operates within any of these various types of communications devices 1230 that include a personal digital assistant (PDA) 1231, a Voice over Internet Protocol (VOIP) phone 1232, a modem 1233, an interactive pager 1234, a Global Positioning System (GPS) device 1235, a digital musical recorder device 1236, any computer system utilizing a digital signal processor 1237, an interactive television 1238, a Plain Old Telephone System (POTS) phone 1239, and/or a computer 1240. The communications device 1230 may also include watches, radios, vehicle electronics, clocks, printers, gateways, and other apparatuses and systems. As those of ordinary skill in the art understand, the communications device 1230 and the Simultaneous Ring Emergency Control Module 325″ (or, alternatively, the communications device 1230 and the Simultaneous Ring Emergency Control Module 325′ of the communications network 120) has the intelligence for appropriate communicating with the emergency, non simultaneous ring communications device 732. For example, if the communications device 1230 uses the Wireless Application Protocol (WAP) technique, then the emergency, shared notification communications signal 735 is formatted using the Wireless Mark-up Language (WML) and configured according to standards known in the art. The Wireless Mark-up Language (WML) and the WAP technique are known and will not be further described. This is a description of a solution for a specific wireless protocol, such as WAP. This solution may be clearly extended to other wireless protocol, such as i-mode, VoiceXML (Voice eXtensible Markup Language), Dual Tone Multi-Frequency (DTMF), and other signaling means. Alternatively, the emergency, shared notification communications signal 735 may be formatted and/or otherwise configured for presentation by an application and/or componentry of the selected, non simultaneous ring communications device 732.

The Simultaneous Ring Emergency Control Module (shown as reference numerals 325, 325′, and 325″ in FIGS. 3-8 and 12) may reside on the emergency provider's communications device, a server-component of the communications network, a remote server, and/or the emergency party's communications devices. Further, the telecommunications network (shown as reference numeral 221 of FIG. 2 and reference numerals 421 of FIGS. 4, and 8) may include wired, optical, and/or wireless elements and may further include private network elements, such as private branch exchanges (PBXs), and/or other elements (not shown). The telecommunications network includes Advanced Intelligent Network (AIN) componentry controlling many features of the network. The telecommunications network and/or each of the switches (shown as reference numerals 205, 207, and 209 of FIGS. 2, 4, and 8) could also include a packet-based “soft switch” that uses software control to provide voice, video, and/or data services by dynamically changing its connection data rates and protocols types. If the telecommunications network and/or one of the switches should include a softswitch, the AIN componentry is replaced by an application server that interfaces with the softswitch via a packet protocol, such as Session Initiation Protocol (SIP). The means of communicating between or among the emergency party's communications address(es), the switches, the telecommunications network including AIN componentry and the Simultaneous Ring Emergency Control Module, the data network (shown as reference numeral 222 of FIGS. 2, 4, and 8) including the gateway (shown as reference numeral 270 of FIGS. 2, 4, and 8), and the emergency provider's communications device (shown as reference numeral 411 of FIGS. 4, and 8) include a variety of means, including optical transmission of data (e.g., any medium capable of optically transmitting the data), wireless transmission of data (e.g., wireless communications of the data using any portion of the electromagnetic spectrum), and/or fixed-wire transmission of data (e.g., any medium capable of transmitting electrons along a conductor). Fiber optic technologies, spectrum multiplexing (such as Dense Wave Division Multiplexing), Ethernet and Gigabit Ethernet services, Infrared, the family of IEEE 802 standards, and Digital Subscriber Lines (DSL) are just some examples of the transmission means. The signaling between the emergency party's communications device, the switches, the telecommunications network, the data network, and the emergency provider's communications device, however, are well understood in by those of ordinary skill the art and will not be further described. Further, those of ordinary skill in the art will be able to apply the principles of this invention to their own network configurations which may differ substantially from the communications system(s) shown in the figures.

The simultaneous ring emergency control application (shown as reference numerals 325, 325′, and 325″ in FIGS. 3-8, and 12) may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the embodiments, allow the Simultaneous Ring Emergency Control application to be easily disseminated.

The simultaneous ring control application may also be physically embodied on or in any addressable (e.g., HTTP, I.E.E.E. 802.11, Wireless Application Protocol (WAP)) wire line or wireless device capable of presenting an IP address. Examples could include a computer, a wireless personal digital assistant (PDA), an Internet Protocol mobile phone, or a wireless pager.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method comprising:
detecting and decoding a communication signal from an priority caller communications address to an called party communications address of a simultaneous ring service, the called party communications address comprising one of a plurality of communications addresses associated with the simultaneous ring service;
disabling the simultaneous ring service to the plurality of communications addresses; and
communicating the communications signal to the called party communications address.

2. The method of claim 1, further comprising:
establishing a communications connection of the called party communications address with the priority caller communications address.

3. The method of claim 1, wherein the step of detecting and decoding the communications signal from the priority caller communications address to the called party communications address comprises associating a simultaneous ring emergency control profile comprising (1) an identification of each of the plurality of communications addresses, (2) an instruction to disable simultaneous ring service to each of the plurality of communications addresses, (3) an instruction to enable priority caller control of the simultaneous ring service to each of the plurality of communications addresses, (4) an instruction to generate an priority notification communications signal having an identifier of the priority caller and an identifier of the called party, (5) an instruction to communicate the priority notification communications signal to a selected communications address of the plurality of communications addresses having disabled simultaneous ring service, and (6) an instruction to manage simultaneous ring emergency control features.

4. The method of claim 3, the identifier of the priority caller comprising the priority caller communications address, a listed name of the priority caller communications address, and a user-selected identifier of the priority caller.

5. The method of claim 3, the identifier of the called party comprising the called party communications address, a listed name of the called party, and a user-selected identifier of the called party.

6. The method of claim 3, further comprising:
communicating the priority notification communications signal to the selected communications address having disabled simultaneous ring service; and
presenting the priority notification communications signal to the selected communications address.

7. The method of claim 3, the priority caller comprising a communications address of an emergency services provider, the called party comprising a party for an emergency service, and the priority notification comprising an emergency notification of a communication among the emergency services provider and the party for the emergency service.

8. A communications system, comprising:
a simultaneous ring priority control application for detecting and decoding a communication signal from an priority caller communications address to an called party communications address of a simultaneous ring service, the simultaneous ring priority control application further for disabling the simultaneous ring service to the plurality of communications addresses and for initiating a communication of the communications signal to the called party communications address,
wherein the called party communications address comprises one of a plurality of communications addresses associated with the simultaneous ring service;

9. The communications system of claim 8, further comprising:
a communications connection among a priority caller communications address and a called party communications address of a simultaneous ring service line;
a database of at least one simultaneous ring priority control profile, the simultaneous ring priority control profile comprising (1) an identification of each of the plurality of simultaneous ring communications addresses, (2) an instruction to disable simultaneous ring service to each of the plurality of simultaneous ring communications addresses, (3) an instruction to enable priority caller control of the simultaneous ring service to each of the plurality of simultaneous ring communications addresses, (4) an instruction to generate an priority notification communications signal having an identifier of the priority caller and an identifier of the called party, (5) an instruction to communicate the priority notification communications signal to a selected communications address of the plurality of communications addresses having disabled simultaneous ring service, and (6) an instruction to manage simultaneous ring priority control features;
a processor, the processor operating with the simultaneous ring priority control application for accessing, processing, and managing the priority caller communications signal, and
a communications interface for communicating the priority caller communications signal over the communications network to the called party communications device.

10. The system of claim 8, the communications network comprising a public switched telephone network, a mobile switching telephone communications network, and a satellite network.

11. The system of claim 8, the priority caller communications address coupled with a priority caller communications device, the priority caller communications device comprising:
a POTS phone,
a wireless communications device,
a mobile phone,
a wireless phone,
a WAP phone,
a satellite phone a computer,
a modem,
a pager,
a digital music device,
a digital recording device,
a personal digital assistant,
an interactive television,
a digital signal processor, and
a Global Positioning System device.

12. The system of claim 8, the called party communications address coupled with a called party communications device, the called party communications device comprising:
a Caller Identification device,
a POTS phone,
a wireless communications device,
a mobile phone,
a wireless phone,
a WAP phone,
a satellite phone a computer,
a modem,
a pager,
a digital music device,
a digital recording device,
a personal digital assistant,
an interactive television,
a digital signal processor, and
a Global Positioning System device.

13. The system of claim 8, the communications network further comprising a world wide electronic data communications network.

14. The system of claim 8, the priority caller communications signal comprising text, voice, video, and electronic data.

15. The system of claim 8, the communications connection comprising a voice connection and a data connection.

16. A computer program product, comprising instructions for:
detecting and decoding a communication signal from an priority caller communications address to an called party communications address of a simultaneous ring service, the called party communications address comprising one of a plurality of communications addresses associated with the simultaneous ring service;
disabling the simultaneous ring service to the plurality of communications addresses; and
communicating the communications signal to the called party communications address.

17. The computer program product of claim 16, further comprising instructions for:
establishing a communications connection of the called party communications address with the priority caller's communications address.

18. The computer program product of claim 16, wherein the instruction for detecting and decoding the communications signal from the priority caller communications address to the called party communications address comprises a further instruction to associate a simultaneous ring priority control profile comprising (1) an identification of each of the plurality of communications addresses, (2) an instruction to disable simultaneous ring service to each of the plurality of communications addresses, (3) an instruction to enable priority caller control of the simultaneous ring service to each of the plurality of communications addresses, (4) an instruction to generate an priority notification communications signal having an identifier of the priority caller and an identifier of the called party, (5) an instruction to communicate the priority notification communications signal to a selected communications address of the plurality of communications addresses having disabled simultaneous ring service, and (6) an instruction to manage simultaneous ring priority control features.

19. The computer program product of claim 18, further comprising instructions for:
communicating the priority notification communications signal to the selected communications address having disabled simultaneous ring service.

20. The computer program product of claim 19, further comprising instructions for:
presenting the priority notification communications signal to the selected communications address.
